(19) United States
(12) Patent Application Publication
(10) Pub. No.: US 2002/0010984 A1
(43) Pub. Date: Jan. 31, 2002

(54) Fittings for use in files

(75) Inventor: Junichi Kumagai, Matsudo-shi (JP)

Correspondence Address: ROBERT R. PRIDDY, HALL, PRIDDY, MYERS & VANDE SANDE, SUITE 200, 10220 RIVER ROAD, POTOMAC, MD, 20854, US

(73) Assignee: World Wide Stationery Manufacturing Company Limited

(21) Appl. No.: 09/850,065

(22) Filed: May 8, 2001

(30) Foreign Application Priority Data
Jul. 28, 2000 (JP) 2000-005391

(51) Int. Cl. B42F 1/00

(52) U.S. Cl. 24/67.11

(57) ABSTRACT

There is disclosed a metal fitting (100, 100a, 100b) adapted to be secured to a base member by at least an eyelet (102, 102a, 102b), in which the metal fitting (100, 100a, 100b) includes at least an aperture (106, 106a, 106b) adapted to receive at least part of the eyelet (102, 102a, 102b), in which at least one tab (108, 110, 108a, 108b) extends from a periphery of the aperture (106, 106a, 106b) into the aperture, and the tab (108, 110, 108a, 108b) is adapted to engage with a flared portion (112, 112a, 112b) of the eyelet (102, 102a, 102b) to secure the metal fitting (100, 100a, 100b) with the base member. There is also disclosed a document holder formed of such a metal fitting as attached to a base member.

### FITTINGS FOR USE IN FILES

This invention relates to a fitting for holding documents, and in particular such a fitting adapted to hold documents and be secured to a base article, and a document holder with such a fitting secured to a base article.

### BACKGROUND OF THE INVENTION

FIG. 4 is a perspective view of the way in which a prior art metal file fitting, generally designated as 1, has up to now generally been attached to a file 3 made of cardboard. FIG. 5 is an enlarged view of a part of the prior art metal file fitting 1 shown in FIG. 4. In the case of the prior art metal fitting 1 herein, for example, the fold at each end of a metal document retention bracket 1c, which has the shape of a rectangle with the left-hand end open, is attached to a lateral edge 1b of a rectangular stainless base 1a by means of a tensioning coil spring 1d. Near each longitudinal end of the rectangular stainless base 1a is a small holes 1e into which an eyelet 2 can be inserted. The eyelets 2 are tube-shaped metal parts inserted into the small holes 1e made in the metal fitting 1 and the file 3, and pressed through from one end to form a joint between the holes.

In recent years the disposal of manufactured goods has become an issue. For example, when disposing of files with the prior art metal fitting 1 attached, the metal fitting 1, which cannot be incinerated, has to be removed from the cardboard file 3, which is combustible, and destroyed separately.

For this reason, when removing the prior art metal fitting 1 from the card file 3, such measures as filing off the flared part of the eyelets 2 had to be used, making the process complicated.

It is thus an object of the present invention to provide a fitting for use in files which simplifies the detachment of the fitting from the file when the part of the file made of cardboard or plastic and its metal part are separated for disposal.

It is a further object of the present invention to provide a fitting for use in files that can be removed from a file relatively easily, even without resorting to measures such as filing down the flared part of the eyelet.

### SUMMARY OF THE INVENTION

According a first aspect of the present invention, there is provided a document holding mechanism adapted to be secured to a base member by at least one securing member, wherein said mechanism includes at least an aperture adapted to receive at least part of said securing member, and wherein at least one engagement member extends from a periphery of said aperture into said aperture, said engagement member being adapted to engage with a flared portion of said securing member to secure said mechanism with said base member.

According to a second aspect of the present invention, there is provided a document holder including a document holding mechanism secured to a base member by at least one securing member, wherein said mechanism includes at least an aperture receiving at least part of said securing member, and wherein at least one engagement member extends from a periphery of said aperture into said aperture, said engagement member being engaged with a flared portion of said securing member to secure said mechanism with said base member.

### BRIEF DESCRIPTION OF THE DRAWINGS

An embodiment of a fitting according to the present invention will now be described, by way of example only, and with reference to the accompanying drawings, in which:

FIG. 1 is a plan view of a metal file fitting according to the present invention;

FIGS. 2A(i) to 2D(ii) show the steps whereby the metal file fitting shown in FIG. 1 is removed from a file;

FIG. 3 is a perspective view showing other forms of application of the metal file fitting shown in FIG. 1;

FIG. 4 is a perspective view of a prior art metal file fitting attached to a file; and

FIG. 5 is an enlarged view showing a part of a prior art metal file fitting shown in FIG. 4.

### DETAILED DESCRIPTION OF PREFERRED EMBODIMENTS

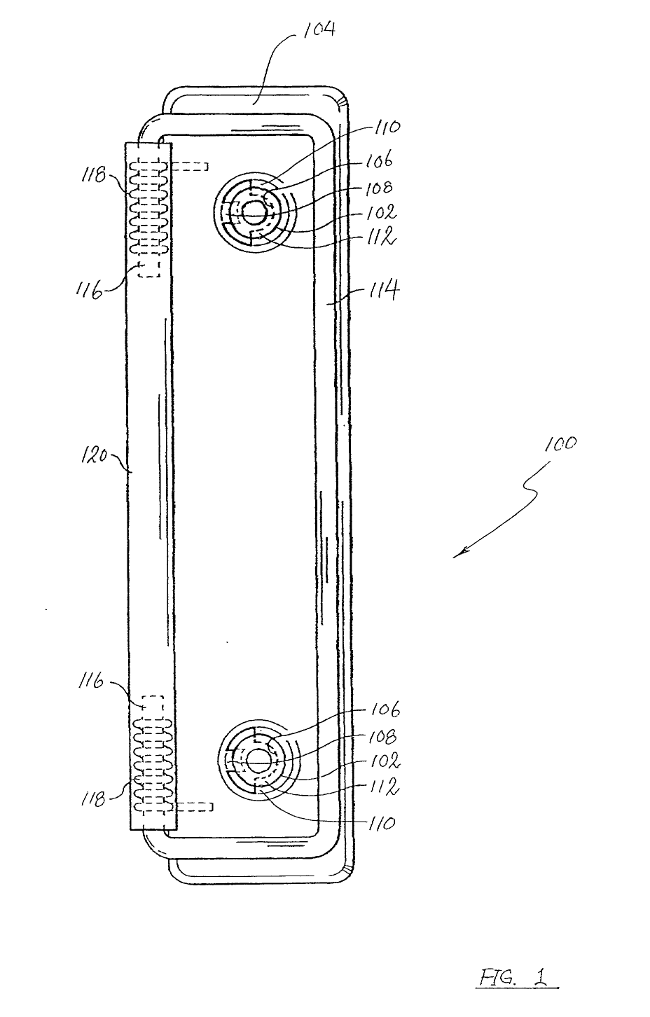

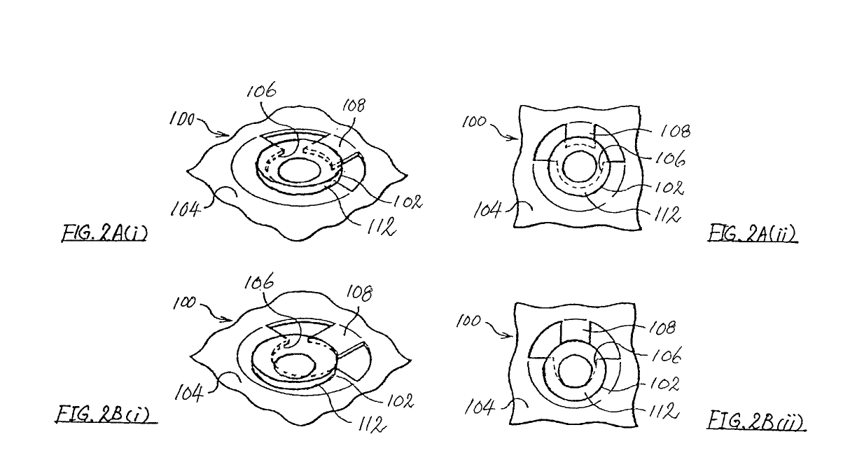

In order to solve or at least to mitigate the problem discussed above, in a metal fitting 100 in the form of a document holding mechanism according to the present invention, and as shown in FIG. 1, a shaft of an eyelet or rivet 102 is inserted through a hole in a base cover (not shown) into a rectangular metal base 104 of the metal fitting 100, which may be made of stainless steel or other metal. The metal base 104 is formed with two apertures 106, each has a generally rectangular tab 108 and a generally semi-circular tab 110 extending into the aperture 106 from a periphery thereof. The tabs 108, 110 are formed integrally with the metal base 104. A flared upper part 112 of the eyelet 102, which may be formed by deformation of an upper end of the eyelet 102, catches the rectangular tab 108 and the semi-circular tab 110 so that the eyelet 102 cannot be withdrawn from the metal fitting 100. Another end of the eyelet 102 may be formed a head which engages the base cover.

By adopting this pattern of the aperture 106, when the metal fitting 100 is to be removed, the rectangular tab 108 in the aperture 106 can be prised upwards by using a tool with a sharp point (such as a screwdriver) so that the flared part 112 of the eyelet 102 can be easily withdrawn, enabling the removal of the metal fitting 100 from the base cover.

The fitting 100 includes a metal document retention bracket 114, which is shaped like a rectangle with the left-hand end open. Folds 116 at both ends of the retention bracket 114 are each attached by means of a tensioning spring 118 to a lateral edge 120 of the metal base 104.

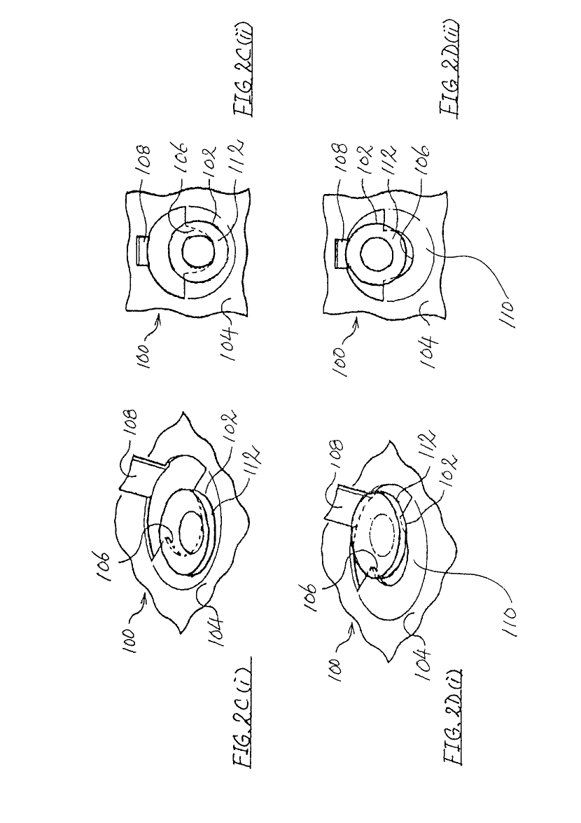

FIGS. 2A(i) to 2D(ii) show the steps for removal of the metal file fitting 100 from the file. FIGS. 2A(i) and 2A(ii) are respectively an oblique perspective view and a plan view illustrating the position when the shaft of the eyelet 102 has been inserted into the aperture 106. The flared part 112 of the eyelet 102 is anchored by the rectangular tab 108 in the aperture 106 so that the eyelet 102 cannot be removed from the metal base 104.

When the metal fitting 100 is to be removed from the file, as is shown by an oblique perspective view FIG. 2B(i) and a plan view FIG. 2B(ii), the fitting 100 may be moved, e.g. being pushed, relative to the base cover, so that the tip of the tab 108 in the aperture 106 formed in the fitting 100 approaches the rim of the flared part 112 of the eyelet 102.

Then, and as shown in an oblique perspective view FIG. 2C(i) and a corresponding plan view FIG. 2C(ii), the tab 108 in the aperture 106 is prised up with a sharp-pointed tool, e.g. a screwdriver. Subsequently, as shown in an oblique perspective view FIG. 2D(i) and a corresponding plan view FIG. 2D(ii), the metal file fitting 100 is moved back so that the rim of the flared part 112 of the eyelet 102 approaches the tab 108 that has been prised up as described above. To the extent necessary, the part of the semi-circular tab 110 that is engaged with the flared part 112 of the eyelet 102 can be prised up with a sharp-pointed instrument, so as to be disengaged from the eyelet 102. The fitting 100 may then be removed from the base cover, e.g. by being prised by the same sharp-pointed tool.

When it comes to prising up the above flared part 112, it is also possible, as shown in FIGS. 2B(i) and 2B(ii), to do this without moving the metal file fitting 100.

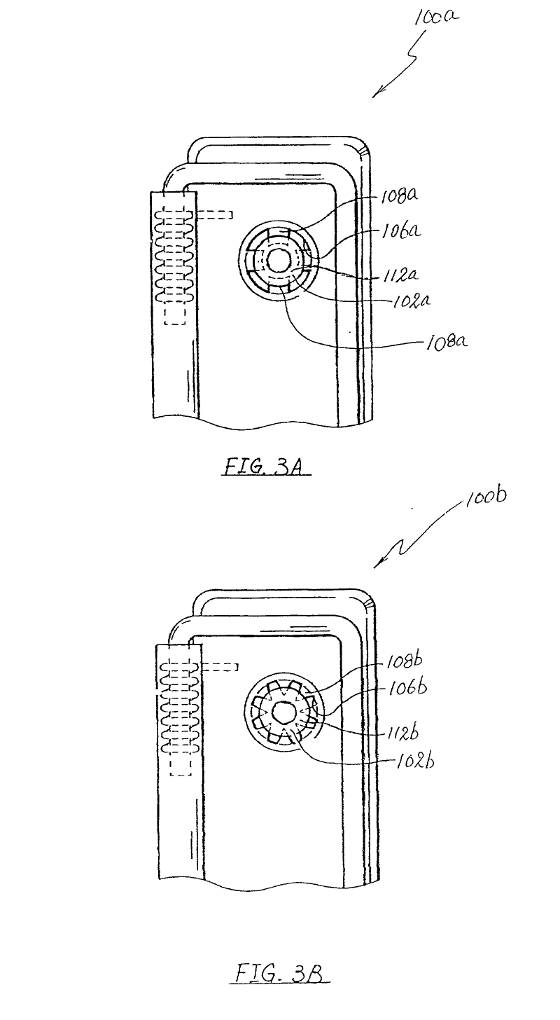

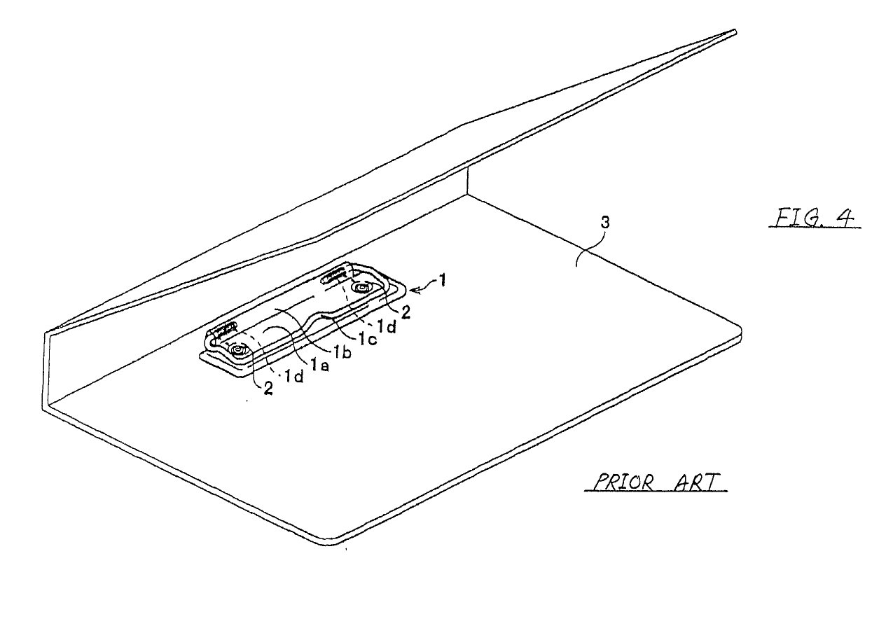

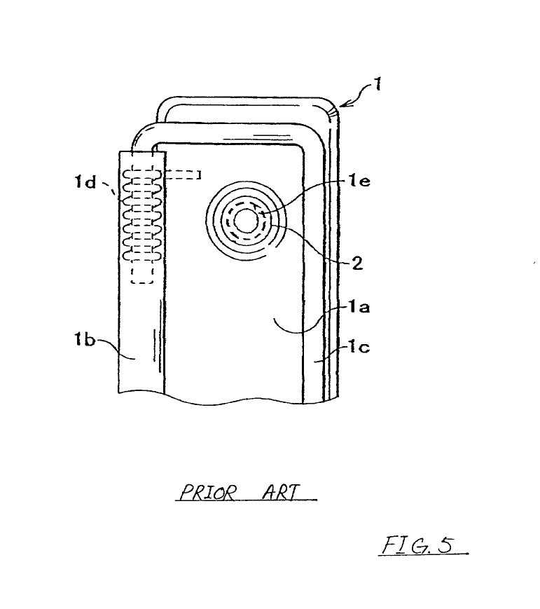

FIG. 3A shows an example of a variation of a fitting 100a, in which the number of tabs 108a in the aperture 106a differs from that of the fitting 100 discussed above. In this example, there are formed four tabs 108a, which are generally equidistant from each other. When the metal file fitting 100a is to be removed, the four tabs 108a are prised upwards with a sharp-pointed instrument. The tabs 108a are then disengaged from a flared part 112a of an eyelet 102a. The metal file fitting 100a may then be prised upwards at a generally right angle to the file and can be easily removed.

FIG. 3B shows another example of a variation of a fitting 100b, in which both the number and shape of tabs 108b extending into an aperture 102b differ from that of the metal fittings 100, 100a discussed above. In this example, eight peak-shaped tabs 108b are formed. The peak-shaped tabs 108 are generally triangular in shape with a vertex thereof pointing towards a centre of an aperture 106b. When the metal file fitting 100b is to be removed, the peak-shaped tabs 108b are prised upwards with a sharp-pointed instrument, so as to disengage the tabs 108b from a flared part 112b of an eyelet 102b. The metal file fitting 100b may then be prised upwards at a generally right angle to the file and can be easily removed. By adopting this peak-shaped configuration, the tabs 108b are easier to prise upwards.

As has been explained above, with a metal file fitting made in accordance with the present invention, that is to say where the shaft of an eyelet can be inserted into an aperture of a rectangular metal base of the metal file fitting, which aperture having at least one tab onto which the flared part of the eyelet catches, so as to prevent withdrawal, the flared part of the eyelet can be easily withdrawn by prising up one or more of the tab(s) extending into the aperture, the metal file fitting can be conveniently removed from the file.

It should be understood that the above only illustrates examples whereby the present invention may be carried out, and that various modifications and/or alterations may be made thereto without departing from the spirit of the invention. In particular, while the present invention has been described in the context of a document holding mechanism with a spring-loaded document retention bracket engaged with a metal base, it is envisaged that the present invention may also be used in a ring binder mechanism in which a pair of carrier plates, to which a number of half-rings are mounted, are carried by a housing for pivoting movement. The ring binder mechanism may be secured to a base cover to form a ring binder. In a known ring binder mechanism, each longitudinal end of the mechanism is provided with a round hole through which a rivet may be inserted. An end of the rivet may then be deformed to secure the ring binder mechanism to the base cover. The present invention may thus be employed in such a ring binder mechanism, e.g. by providing one or more prisable tabs extending from a periphery towards the centre of the hole formed at each longitudinal end of the ring binder mechanism.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A document holding mechanism adapted to be secured to a base member by at least one securing member, wherein said mechanism includes at least an aperture adapted to receive at least part of said securing member, and wherein at least one engagement member extends from a periphery of said aperture into said aperture, said engagement member being adapted to engage with a flared portion of said securing member to secure said mechanism with said base member.

2. A mechanism according to claim 1 wherein a plurality of engagement members extend from said periphery of said aperture into said aperture.

3. A mechanism according to claim 1 wherein said at least one engagement member is movable relative to a body member of said mechanism to allow detachment of said mechanism from said securing member.

4. A mechanism according to claim 3 wherein a plurality of engagement members are movable relative to said body member of said mechanism to allow detachment of said mechanism from said securing member.

5. A mechanism according to claim 1 wherein said engagement member is integral with a body member of said mechanism.

6. A mechanism according to claim 1 wherein each or said engagement member comprises a generally rectangular tab member.

7. A mechanism according to claim 1 wherein each or said engagement member comprises a generally semi-circular arc tab member.

8. A mechanism according to claim 1 wherein each or said engagement member comprises a generally triangular tab member with a vertex thereof pointing generally towards a centre of said aperture.

9. A document holder including a document holding mechanism secured to a base member by at least one securing member, wherein said mechanism includes at least an aperture receiving at least part of said securing member, and wherein at least one engagement member extends from a periphery of said aperture into said aperture, said engagement member being engaged with a flared portion of said securing member to secure said mechanism with said base member.
